(19) United States
(12) Patent Application Publication
(10) Pub. No.: US 2011/0228659 A1
(43) Pub. Date: Sep. 22, 2011

(54) COLLISION PREVENTION METHOD AND APPARATUS BETWEEN RECORDING MEDIUM AND LENS

(76) Inventors: Bong Sik Kwak, Gyeonggi-do (KR); Jeong Kyo Seo, Gyeonggi-do (KR); Jae Sung Lee, Gyeonggi-do (KR)

(21) Appl. No.: 13/119,187

(22) PCT Filed: Sep. 14, 2009
(86) PCT No.: PCT/KR09/05204

§ 371 Date: Mar. 16, 2011

(30) Foreign Application Priority Data
Sep. 17, 2008 (KR) 10-2008-0091182

(51) Int. Cl. G11B 7/08

(52) U.S. Cl. 369/47.49; G9B/7.041

(57) ABSTRACT

A method and apparatus for preventing a collision between a recording medium and a lens are disclosed. The method for preventing the collision between the recording medium and the lens includes controlling a gap error signal (GES) between the recording medium and the lens to be maintained at a near field level, detecting a collision between the recording medium and the lens, pulling out the lens from the recording medium during a predetermined time so as to prevent a re-collision between the recording medium and the lens, and re-controlling the gap error signal (GES) between the recording medium and the lens to be re-maintained at the near field level.

### TECHNICAL FIELD

The present invention relates to a method and apparatus for preventing a recording medium from colliding with a lens when the recording medium rotates.

### BACKGROUND ART

In general, an optical recording/reproducing apparatus records/reproduces data in/from a recording medium of various disc types. In recent times, as the preferences of consumers have rapidly changed, a technology for processing high-quality moving images is required. In addition, as a technology for compressing such moving images, the demand of developing a high-density recording medium rapidly increases. For this purpose, a variety of high-density recording medium technologies have been developed, for example, a Blu-ray Disc (BD) based on a short wavelength blue ray, a high-density DVD (HD-DVD), and a near field recording (NFR) unit based on near field optics. In order to effectively record/reproduce data in/from the above-mentioned high-density disc, the high-density disc has been designed to have a plurality of recording layers.

A Near Field Recording (NFR) device additionally applies a Solid Immersion Lens (SIL) to an objective lens of an optical unit so as to increase a numerical aperture (NA), such that it can record and reproduce data using the increased NA. The above-mentioned NFR scheme limits a gap between the SIL of a pickup unit and a recording medium to tens of nanometers, and at the same time records data in the medium. According to the NFR scheme, a performance or throughput of the recording/reproducing apparatus can be decided by a gap between the SIL and the medium, the size of a beam arrived at a disc, and recording characteristics of a specific pulse.

A near field optical storage unit has a very narrow interval between a disc acting as a medium and the SIL, such that an unexpected collision between the SIL and the disc may occur when the surface of the disc is polluted or scratched. This collision may make a gap servo unit and a tracking servo unit unstable, or may incur unexpected errors in reproducing data.

### DISCLOSURE OF INVENTION

### Technical Problem

An object of the present invention is to provide a method and apparatus for minimizing the influence caused by a collision between a recording medium and a lens, and quickly stabilizing a servo unit.

Another object of the present invention is to provide a method and apparatus for preventing a re-collision between a recording medium and a lens.

A further object of the present invention is to provide a method for establishing an optimum tilt condition where a recording medium does not collide with a lens.

### Technical Solution

The object of the present invention can be achieved by providing a method for preventing a collision between a recording medium and a lens, the method including controlling a gap error signal (GES) between the recording medium and the lens to be maintained at a near field level, detecting a collision between the recording medium and the lens, pulling out the lens from the recording medium during a predetermined time so as to prevent a re-collision between the recording medium and the lens, and re-controlling the gap error signal (GES) between the recording medium and the lens to be re-maintained at the near field level.

The method may further include determining the occurrence of the collision between the recording medium and the lens, if the gap error signal (GES) is changed to at least predetermined level or reaches a far field level. The predetermined time may be changed according to a defect or scratch size of the recording medium.

In another aspect of the present invention, there is provided a method for preventing a collision between a recording medium and a lens, the method including recording a collision—occurred time point between the recording medium and the lens, establishing a collision—occurred expectation area point using not only the collision—occurred time point but also a time consumed for one rotation of the recording medium, and pulling out the lens from the recording medium during a predetermined time at the collision occurred expectation area point.

The predetermined time may be changed according to a defect or scratch size of the recording medium. The method may further include maintaining the pull-out status during a specific time shorter than the predetermined time.

In another aspect of the present invention, there is provided a method for preventing a collision between a recording medium and a lens, the method including establishing an initial tilt condition between the lens and the recording medium, detecting a gap error signal (GES) waveform caused by rotation of the recording medium under the condition that the initial tilt condition is established, determining whether the tilt condition is an optimum condition on the basis of the gap error signal (GES) waveform, and if the tilt condition is not the optimum condition, changing the tilt condition to a new tilt condition, and detecting the gap error signal (GES) waveform under the new tilt condition.

The gap error signal (GES) waveform may include information about a generation frequency of the gap error signal (GES) and information about a signal level magnitude.

In a further aspect of the present invention, there is provided an apparatus for preventing a collision between a recording medium and a lens, the apparatus including a lens for illuminating a light beam emitted from a light source on the recording medium, and a control unit which controls a gap error signal (GES) between the recording medium and the lens to be maintained at a near field level, if a collision between the recording medium and the lens is detected, pulls out the lens from the recording medium for a predetermined time so as to prevent a re-collision between the recording medium and the lens, and then re-controls the gap error signal (GES) between the recording medium and the lens to be maintained at the near field level.

### Advantageous Effects

A collision prevention method and an apparatus thereof according to the present invention can minimize the number of collision times generated when data is recorded/reproduced, such that a data playback quality can be greatly increased.

In addition, the collision prevention method and apparatus can reduce the number of generable collision times under an optimum tilt condition, and can prevent the lens from being polluted by such collisions, thereby increasing the stability of a system.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a block diagram illustrating a collision prevention apparatus according to an embodiment of the present invention.

FIG. 2 is a block diagram illustrating the configuration of an optical system of an optical pickup unit according to an embodiment of the present invention.

FIG. 3 is a schematic side cross-sectional view showing a lens unit and a recording medium according to an embodiment of the present invention.

FIGS. 4 and 5 are conceptual diagrams illustrating a collision between a solid immersion lens (SIL) and a recording medium according to the present invention.

FIG. 6 is a conceptual diagram illustrating a procedure for adjusting a gap between the SIL and the recording medium so as to minimize the influence caused by a collision under the condition that the recording medium collides with the SIL according to a first embodiment of the present invention.

FIG. 7 is a graph illustrating the result of comparison between a gap error signal (GES) acquired when a gap adjustment algorithm is used and the other GES acquired when no gap adjustment algorithm is used according to a first embodiment of the present invention.

FIG. 8 is a graph illustrating a procedure for separating a recording medium from the SIL at an expected collision point so as to prevent a re-collision between the recording medium and the SIL under the condition that the recording medium has collided with the SIL according to a second embodiment of the present invention.

FIGS. 9 to 11 are flowcharts sequentially illustrating the separation procedure (or the pull-out procedure) shown in FIG. 8.

FIGS. 12 and 13 are graphs illustrating the result of comparison of GES waveforms generated when the recording medium collides with the lens in such a manner that the tilt adjustment mechanism of FIG. 14 can be explained.

FIG. 14 is a flowchart illustrating a tilt adjustment mechanism for reducing the number of collisions between the recording medium and the lens according to a third embodiment of the present invention.

FIG. 15 is a graph illustrating the result of comparison of waveforms of a GES level differently generated according to a tilt value according to a third embodiment of the present invention.

FIGS. 16 and 17 are graphs illustrating the result of comparison between one result acquired before the collision prevention method is used and the other result acquired after the collision prevention method is used according to a fourth embodiment of the present invention.

### BEST MODE FOR CARRYING OUT THE INVENTION

Reference will now be made in detail to the preferred embodiments of the present invention, examples of which are illustrated in the accompanying drawings. Also, wherever possible, the same reference numbers will be used throughout the drawings to refer to the same or like parts. For convenience of description and better understanding of the present invention, the collision prevention method and apparatus will hereinafter be described using the data recording/reproducing method and apparatus as an example.

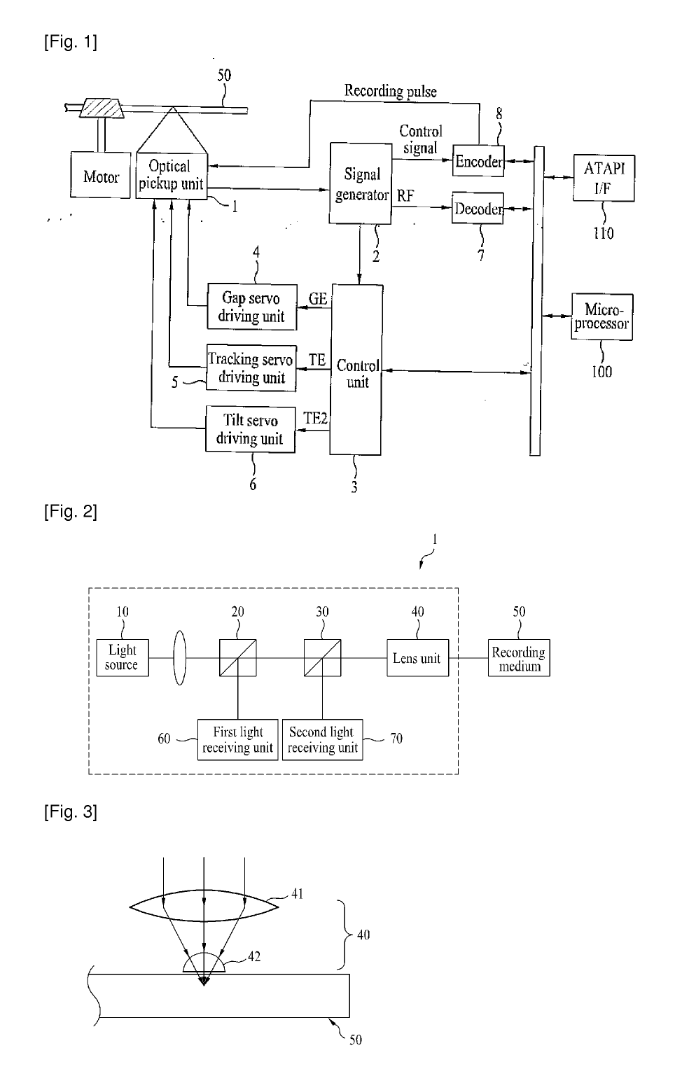

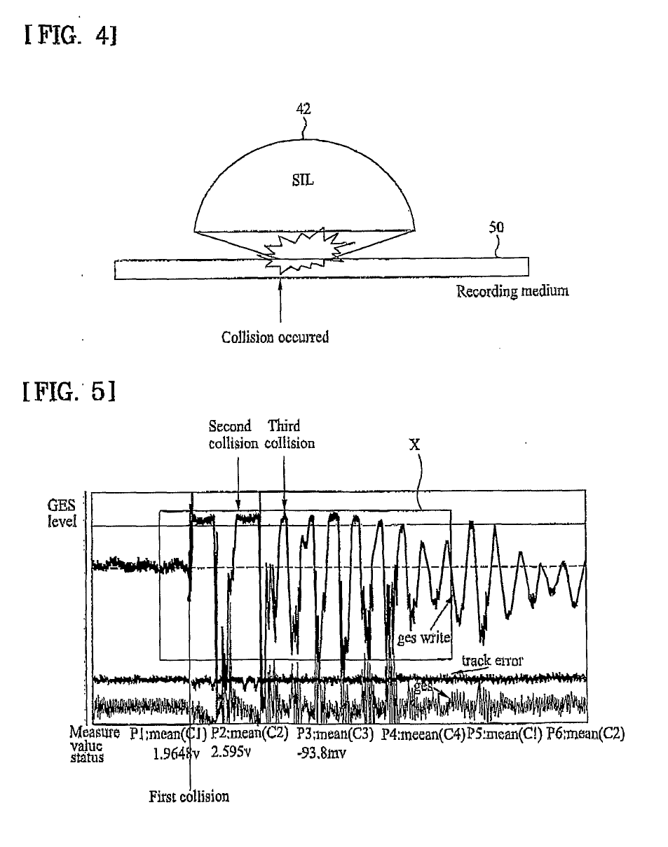

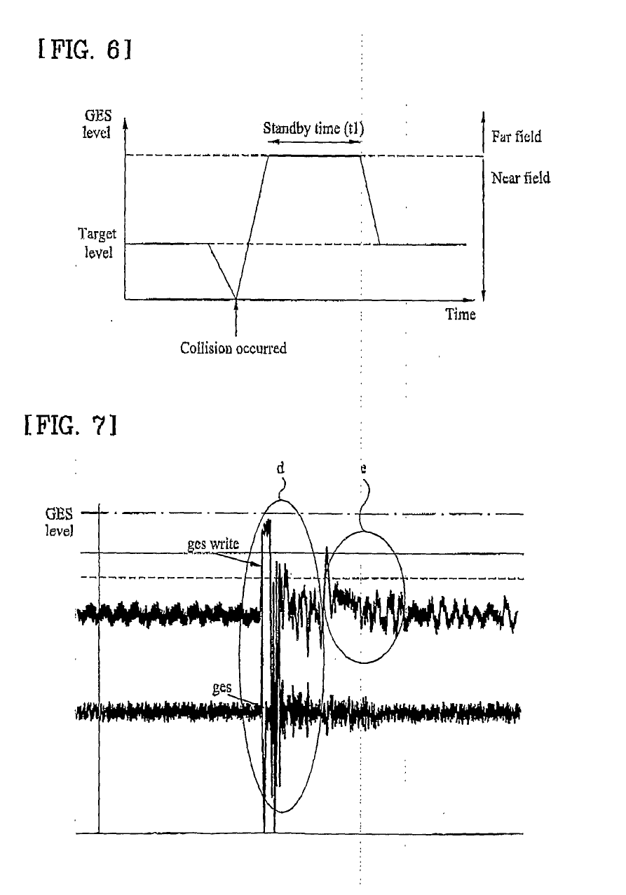

FIG. 1 is a block diagram illustrating a collision prevention apparatus according to an embodiment of the present invention. The configuration of the collision prevention apparatus will be described in detail with reference to FIGS. 2 and 3.

An optical pickup unit 1 illuminates a light beam onto a recording medium, focuses the light beam reflected from the recording medium, and generates a signal. An optical system (not shown) included in the optical pickup unit 1 may be configured as shown in FIG. 2. That is, the optical pickup unit 1 may include a light source 10, separation/combination units 20 and 30, a lens unit 40, and light receiving units such as photodetectors 60 and 70.

The light source 10 may use a laser having an excellent rectilinear propagation property. Therefore, the light source 10 is, for example, a laser diode. The light beam, which emerges from the light source 10 and is illuminated on the recording medium 50, may be a parallel light beam. Therefore, a lens (e.g., a collimating lens) for converting a light beam emerged from the light source 10 into a parallel light beam may be provided on the path of the light beam.

The separation/combination units 20 and 30 separate light beams incident from the same direction from each other, or synthesize other light beams incident from different directions. In the present embodiment, the first separation/combination unit 20 and the second separation/combination unit 30 are included. The first separation/combination unit 20 passes a part of the incident light beam and reflects another part of the incident light beam (in the present embodiment, the first separation/combination unit 20 is a non-polarized beam splitter (NBS)). The second separation/combination unit 30 passes only light beam which is polarized in a specific direction according to a polarization direction (in the present embodiment, the second separation/combination unit 30 is a polarized beam splitter (PBS)). For example, when a linearly polarized light beam is used, the second separation/combination unit 30 may pass only a vertically polarized component and reflect a horizontally polarized component. Alternatively, the second separation/combination unit 30 may pass only a horizontally polarized component and reflect a vertically polarized component.

The lens unit 40 transmits the light beam emitted from the light source 10 to the recording medium 50. The lens unit 40 according to the embodiment of the present invention includes an objective lens 41 and a solid immersion lens (SIL) 42 provided on a path along which the light beam passing through the objective lens 41 enters the recording medium. That is, by providing the SIL 42 having a high refractive index in addition to the objective lens 41, the numerical aperture (NA) of the lens unit 40 increases and thus an evanescent wave is formed. The SIL 42 may be a hemisphere or super-hemisphere (a portion of a sphere having a height smaller than that of a sphere and larger than that of a hemisphere is called a super-hemisphere) lens formed by cutting a sphere lens.

The optical system of the optical pickup unit including the lens unit 40 is located close to the recording medium 50. That is, the relative positional relationship between the lens unit 40 and the recording medium 50 is as follows. When the lens unit 40 and the recording medium 50 are close to each other by about ¼ (that is, ¼) or less of a light wavelength, a part of the light beam which enters the lens unit 40 at a threshold angle or more forms the evanescent wave, which passes through the recording medium 50 to reach a recording layer, without totally reflecting from the surface of the recording medium 50. The evanescent wave which reaches the recording layer may be used for recording/reproduction. However, when the distance between the lens unit 40 and the recording medium 50 increases to ¼ or more, the light wavelength loses evanescent wave properties and returns to an original wavelength, which totally reflects from the surface of the recording medium 50. Therefore, in the recording/reproducing apparatus using the near field, the distance between the lens unit 40 and the recording medium 50 is maintained at about ¼ or less. Here, ¼ is a near field limitation.

The light receiving units 60 and 70 receive the reflected light beams and transform the received light beams into electric signals. In the present embodiment, the first light receiving unit 60 and the second light receiving unit 70 are included. The first light receiving unit 60 or the second light receiving unit 70 may include two photodetectors PDA and PDB which are halved in a radial direction or a signal track direction of the recording medium 50. The photodetectors PDA and PDB generate electric signals A and B proportional to the amount of the received light beam. Alternatively, the light receiving unit 60 or 70 may include four photodetectors PDA, PDB, PDC and PDD which are halved in the radial direction and the signal track direction of the recording medium 50. The photodetectors included in the light receiving units 60 and 70 are not limited to the present embodiment and may be variously modified if necessary.

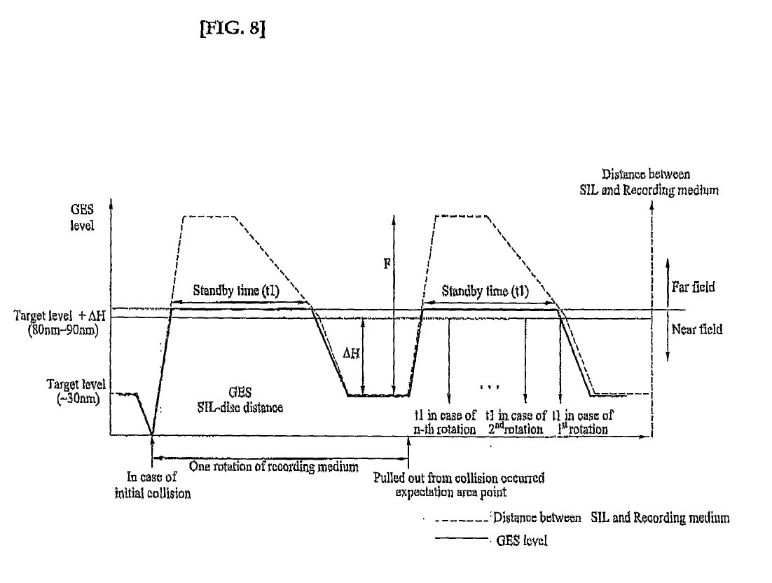

The signal generator 2 shown in FIG. 1 generates a radio frequency (RF) signal necessary for data reproduction, a gap error signal (GE) and a tracking error signal (TE) necessary for servo control, using the signal generated in the optical pickup unit 1. These signals will be described in detail with reference to FIG. 4.

The control unit 3 receives the signal generated from the light receiving units 60 and 70 or the signal generator 2 and generates a control signal or a drive signal. For example, the control unit 3 processes the gap error signal (GE) and outputs a drive signal for controlling the distance between the lens unit 40 and the recording medium 50 to the gap servo driving unit 4. The control unit 3 processes the tracking error signal (TE) and outputs a drive signal for controlling tracking to the tracking servo driving unit 5. When a track seek command is input or a track needs to be sought, the control unit 3 outputs the drive signal to the tracking servo driving unit 5 such that the lens unit 40 or the optical pickup unit 1 can move according to a tracking seek distance. In addition, the control unit 3 performs signal processing of a tilt error such that it outputs a tilt error signal (TE2) for controlling a tilt to the tilt servo driving unit 6.

In more detail, according to the embodiment of the present invention, a gap error signal (GE) between the recording medium 50 and the lens unit 40 is maintained at a near field level. In this case, if a collision between the recording medium and the lens unit 40 is detected, the control unit pulls out (or separates) the lens unit 40 from the recording medium 50 for a predetermined time so as to prevent the occurrence of a re-collision between the recording medium 50 and the lens unit 40, and then re-controls the above gap error signal (GE) to be maintained at the near field level.

The control unit 3 records a collision time point (hereinafter referred to as a collision occurred time point) at which the recording medium collides with the lens unit, and establishes a collision occurred expectation area point using the collision occurred time point and a time consumed while the recording medium is rotated once, such that it may control the lens unit from being pulled out (or separated) from the recording medium for a predetermined time at the collision occurred expectation area point.

Under the condition that an initial tilt condition between the lens unit and the recording medium is established, the control unit 3 detects a waveform of the gap error signal (GES) caused by the rotation of the recording medium, and determines whether the tilt condition is an optimum condition on the basis of the GES waveform. If the tilt condition is not the optimum condition, the control unit 3 changes the tilt condition to another tilt condition, such that it detects the waveform of the gap error signal (GES).

The gap servo driving unit 4 drives an actuator (not shown) contained in the optical pickup unit 1, such that it vertically moves the optical pickup unit 1 or the lens unit 40 of the optical pickup unit 1. Accordingly, it is possible to uniformly maintain the distance between the lens unit 40 and the recording medium 50.

The gap servo driving unit 4 may also perform a focus servo function. For example, the optical pickup unit 1 or the lens unit 40 of the optical pickup unit 1 may trace the vertical movement together with the rotation of the recording medium 50 according to a signal for focus control of the control unit 3.

The tracking servo driving unit 5 drives a tracking actuator (not shown) in the optical pickup unit 1 to move the optical pickup unit 1 or the lens unit 40 of the optical pickup unit 1 in a radial direction such that the position of the light beam is corrected. The optical pickup unit 1 or the lens part 40 of the optical pickup unit may trace a certain track provided on the recording medium 50. The tracking servo driving unit 5 may move the optical pickup unit 1 or the lens unit 40 of the optical pickup unit 1 in the radial direction according to a track seek command.

The tilt servo driving unit 6 may drive the actuator contained in the optical pickup unit 1 or apply an offset, such that it can correct a tilt between the optical pickup unit and the recording medium 50. As a result, the collision prevention apparatus according to the present invention can correct an error caused by a tilted recording medium or can also correct another error caused by a tilt between the optical pickup unit and the recording medium seated in a drive.

A host such as a personal computer (PC) may be connected to the above-mentioned collision prevention apparatus. The host transmits a distance control command and the like to the microprocessor 100 via an interface, receives a corresponding command from the decoder 7, and transmits a command to be recorded to the encoder 8. The microprocessor 100 controls the decoder 7, the encoder 8, and the control unit 3 upon receiving the distance control command from the host.

The interface may generally use an advanced technology attached packet interface (ATAPI) 110. The ATAPI 110 is an interface standard between a collision prevention apparatus such as a CD or DVD drive and the host such that the collision prevention apparatus transmits a decoded command to the host. The ATAPI 110 converts the decoded command into a protocol configured in a packet form which can be processed in the host and transmits the protocol to the host.

FIGS. 4 and 5 are conceptual diagrams illustrating a collision between a solid immersion lens (SIL) 40 and a recording medium 50 according to the present invention.

If a gap servo operation is stably performed without generating any collision between the recording medium and the SIL, the gap error signal (GES) can be uniformly maintained at a predetermined gap level. However, if there is a collision between the SIL 42 and the recording medium 50 as shown in FIG. 4, the gap error signal (GES) largely fluctuates on the basis of the collision occurred time point as shown in FIG. 5. As can be seen from FIG. 5, the GES level corresponding to y-axis coordinates is abruptly changed from the collision—occurred time point. That is, it can be readily recognized that a first collision occurs, and then second and third collisions occur by vibration of the lens. Subsequently, more collisions further occur, such that the GES level becomes unstable for a long period of time during which data is reproduced.

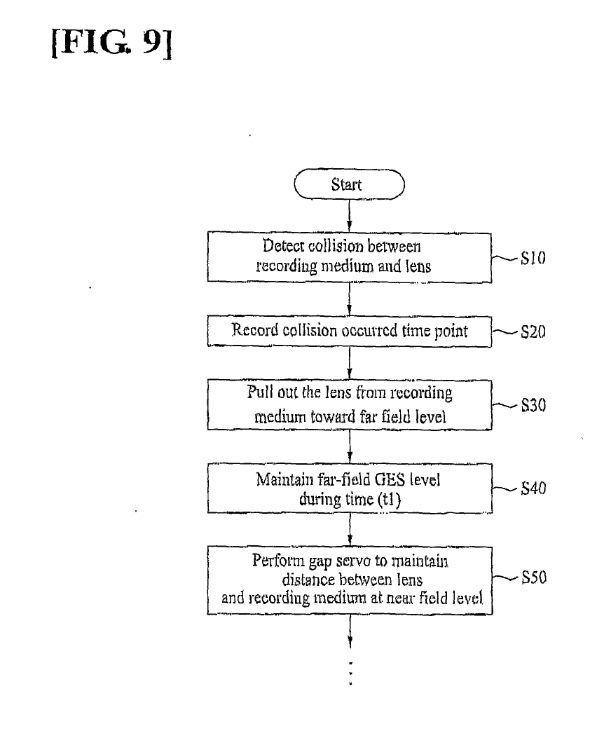

FIG. 6 is a conceptual diagram illustrating a procedure for adjusting a gap between the SIL 42 and the recording medium 50 so as to minimize the influence caused by a collision under the condition that the recording medium collides with the SIL according to a first embodiment of the present invention.

Referring to FIG. 6, in order to control the distance between the SIL 42 and the recording medium 50, the GES level is maintained at a predetermined value before a collision between the SIL 42 and the recording medium 50 occurs. That is, the GES level is maintained at a near field level before the collision occurs. In this way, the operation for controlling the distance between the SIL and the recording medium 40 using the GES is indicative of the above-mentioned gap servo operation. If it is assumed that the collision between the SIL 42 and the recording medium 50 occurs while the gap servo function operation is carried out to maintain a target level corresponding to the GES level acquired when the distance between the SIL 42 and the recording medium 50 is most appropriately controlled within a predetermined range causing no collision, specifically, if it is assumed that the GES level is changed to either a predetermined level or more or reaches a far field level, this means that a first collision between the SIL and the recording medium has occurred. If the first collision has occurred, the SIL 42 is pulled out (or separated) from the recording medium 50 so as to prevent the occurrence of re-collision caused by the first collision. In this case, the separation status can be maintained during a predetermined time under the condition that the GES level is higher than the target level or reaches a far field level. In this case, the predetermined time, which is indicative of a standby time (t1) shown in FIG. 6, may be changed according to a defect or scratch size of the recording medium 50. Since it is impossible to read or write data from or in the recording medium during the standby time (t1), it is preferable that the standby time (t1) be reduced. An implementation method for reducing the standby time (t1) will be described later. In order to prevent the occurrence of re-collision, the SIL 42 is again pulled out from the recording medium during a predetermined time, is again pulled in the recording medium 50, and thus re-controls the GES level to be reduced to the target level in such a way that the gap servo operation is carried out. That is, if a collision between the SIL 42 and the recording medium 50 occurs, the collision prevention apparatus according to the present invention again maintains the gap servo as described above, such that it can prevent the occurrence of second and third collisions.

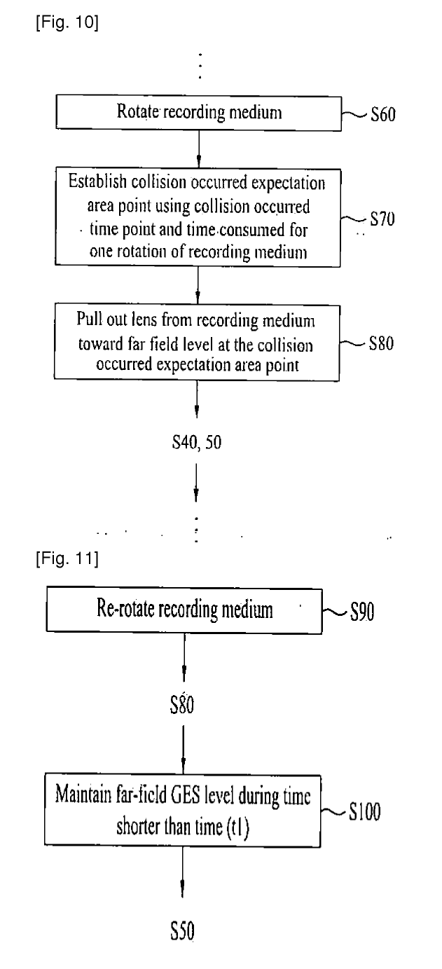

FIG. 7 is a graph illustrating the result of comparison between a GES level acquired when a gap adjustment algorithm is used and the other GES level acquired when no gap adjustment algorithm is used according to the embodiment of the present invention.

As can be seen from FIG. 7, ‘d’ means that second and third collision continuously occur after the first collision has occurred under the condition that no gap adjustment algorithm has been used, such that the GES level continues to be unstably changed. Otherwise, ‘e’ means that no collision occurs after the first collision has occurred under the condition that the gap adjustment algorithm has been used.

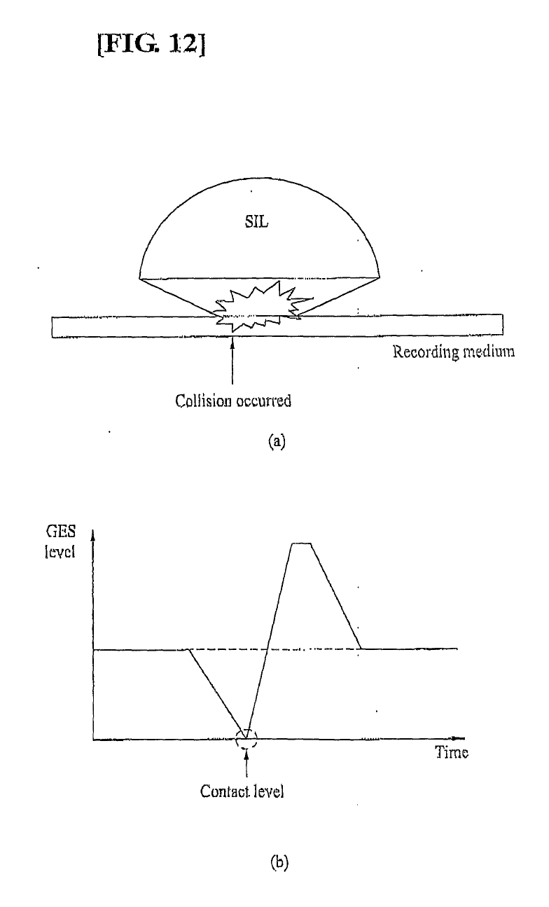

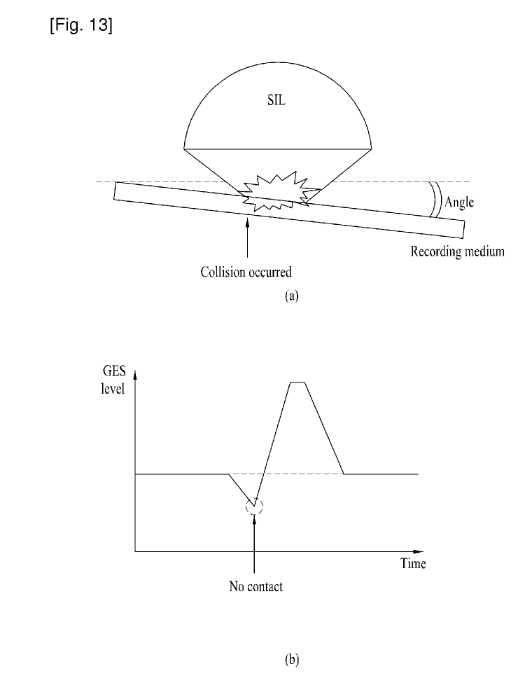

FIG. 8 is a graph illustrating a procedure for separating a recording medium 50 from the SIL 42 at an expected collision point so as to prevent the occurrence of re-collision under the condition that one collision between the recording medium 50 and the SIL 42 has occurred. FIGS. 9 to 11 are flowcharts sequentially illustrating the separation procedure shown in FIG. 8, and detailed descriptions thereof will be described with reference to FIG. 8 in addition to FIGS. 9 and 11.

In the graph shown in FIG. 8, the GES level is denoted by a solid line, and the distance between the SIL 42 and the recording medium 50 is denoted by a dotted line.

As shown in FIG. 8, if a collision between the SIL 42 and the recording medium 50 occurs during the gap servo operation for maintaining a target level corresponding to the GES level provided when the distance between the SIL 42 and the recording medium 50 is maintained at an optimum value within a predetermined range causing no collision at step S 10, the collision prevention apparatus records information about a collision occurred time point at step S20, and at the same time separates (or pulls out) the SIL 42 from the recording medium 50 so as to make the GES level be higher than the target level or be equal to the far field level at step S30. If it is assumed that the SIL 42 is separated from the recording medium 50 so as to allow the GES level to reach the far field level, the distance between the SIL 42 and the recording medium 50 may be the far field level or more as denoted by ‘F’ in FIG. 8. The pull-out (or separation) status between the SIL and the recording medium can be maintained for a predetermined time at step S40. In this case, the predetermined time indicative of a standby time (t1) of FIG. 8 may be changed according to the defect or scratch size of the recording medium 50. The SIL 42 is pulled out from the recording medium 50 during a predetermined time, is pulled in the recording medium 50, and thus re-controls the GES level to be reduced to the target level in such a way that the gap servo process is carried out at step S50. In more detail, after the SIL 42 is pulled in the recording medium 50 so as to reduce the GES level from a far field level to a level of (target level+delta H), a linear approach capable of reducing the resultant GES level from the level of (target level+delta H) to the target level is carried out in such a way that the gap servo is controlled so that the SIL 42 is pulled in the recording medium 50. If the GES level attempts to approach the near field level, the GES variation occurs at the level of (target level+delta H). For example, when using the blue-ray wavelength of 405 nm, the point of about 80 nm˜90 nm under the near field boundary of 100 nm is set to the level of (target level+delta H). Therefore, if the target level is 30 nm, delta H may be in the range of 50 nm˜60 nm.

The recording medium is pulled out from the SIL at the collision—occurred time point, the gap servo process is carried out, and the recording medium is rotated once at step S60. The collision—occurred time point is detected and a time consumed for one rotation of the recording medium 50 is measured, such that the collision—occurred expectation area point is established at step S70. In other words, the time consumed for one rotation of the recording medium 50 is measured using an equation denoted by (2* Radius of Recording Medium/Rotation linear velocity of Recording Medium), and a time point corresponding to the time consumed for one rotation of the recording medium 50 may be used as a collision occurred expectation area point. Subsequently, the SIL 42 is pulled out from the recording medium 50, such that the GES level is higher than the target level or reaches the far field level at the collision occurred expectation area point at step S80. Steps S40 and S50 for controlling the lens to be pulled out from the recording medium during the standby time (t1) and then performing the gap servo operation are the same as described above.

In addition, it is impossible to read or write data from or in the recording medium during the standby time (t1), such that it is preferable that the rotation speed of the recording medium be reduced or the standby time (t1) be reduced so as to reduce the amount of lost data. In this way, the process for reducing the standby time (t1) by rotating the recording medium several times can be carried out.

That is, the recording medium is rotated again at step S90, and the SIL 42 is pulled out from the recording medium 50 so that the GES level is higher than the target level or reaches the far field level at the collision occurred expectation area point at step S80. In more detail, the SIL 42 is pulled out (or separated) from the recording medium 50 during another standby time (t2) shorter than the standby time (t1) at step S100. The above-mentioned operations are shown as the process for reducing a total standby time by the first rotation, the second rotation, and the n-th rotation in the graph of FIG. 8. Although FIGS. 10 and 11 show an exemplary procedure for reducing the standby time by rotating the recording medium twice, it is obvious to those skilled in the art that the above procedure may also be repeated N times so as to minimize the standby time.

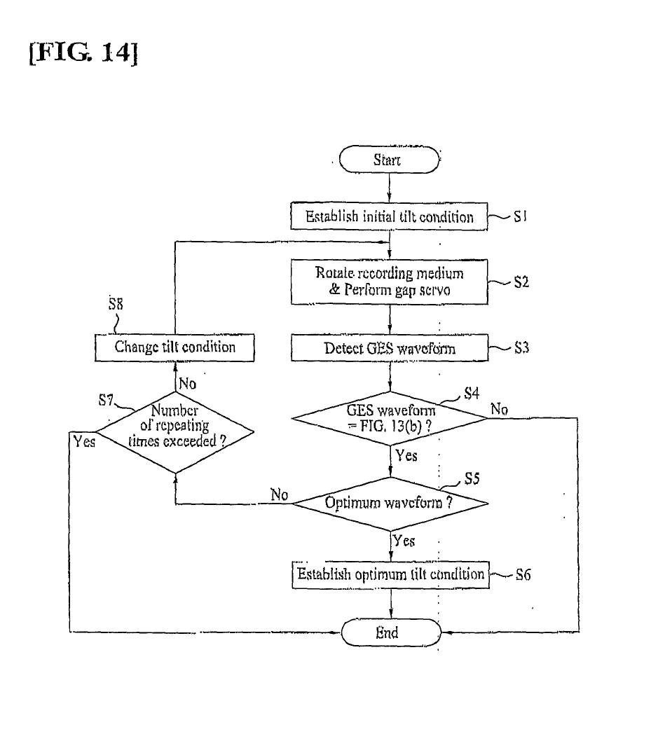

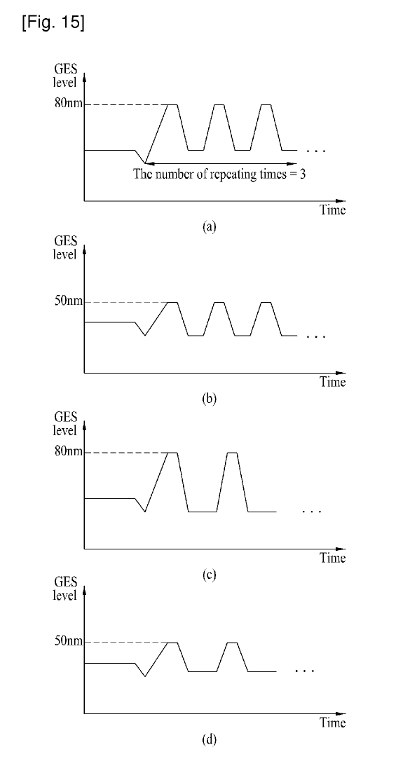

FIGS. 12 and 13 are graphs illustrating the result of comparison of GES waveforms generated when the recording medium collides with the lens in such a manner that the tilt adjustment mechanism of FIG. 14 can be explained.

As shown in FIG. 12(a), if there is a collision between the recording medium 50 and the SIL 42 under the condition that the recording medium 50 and the bottom of the SIL 42 are horizontal, the GES waveform is reduced to the vicinity of the contact level indicating the GES level generated when the SIL 42 is brought into contact with the recording medium 50 as shown in FIG. 12(b), and is then increased.

On the other hand, if the recording medium 40 collides with the bottom of the SIL 42 at a specific angle without being horizontal with respect to the bottom of the SIL 42 as shown in FIG. 13(a), the GES waveform rises under the condition that the GES level has not fallen down to the vicinity of the contact level as shown in FIG. 13(b). In fact, in most cases, the number of FIG. 13 cases, each of which shows that the SIL 42 and the bottom of the SIL 42 collide with each other at a specific angle so as to form the GES waveform shown in FIG. 13(b) is generally higher than the number of FIG. 12 cases, each of which shows the SIL 42 is horizontal with respect to the recording medium 50. Accordingly, a recording medium tilt condition for detecting an optimum waveform can be established by detecting the GES waveform shown in FIG. 13(b), and a detailed description thereof will hereinafter be described in detail.

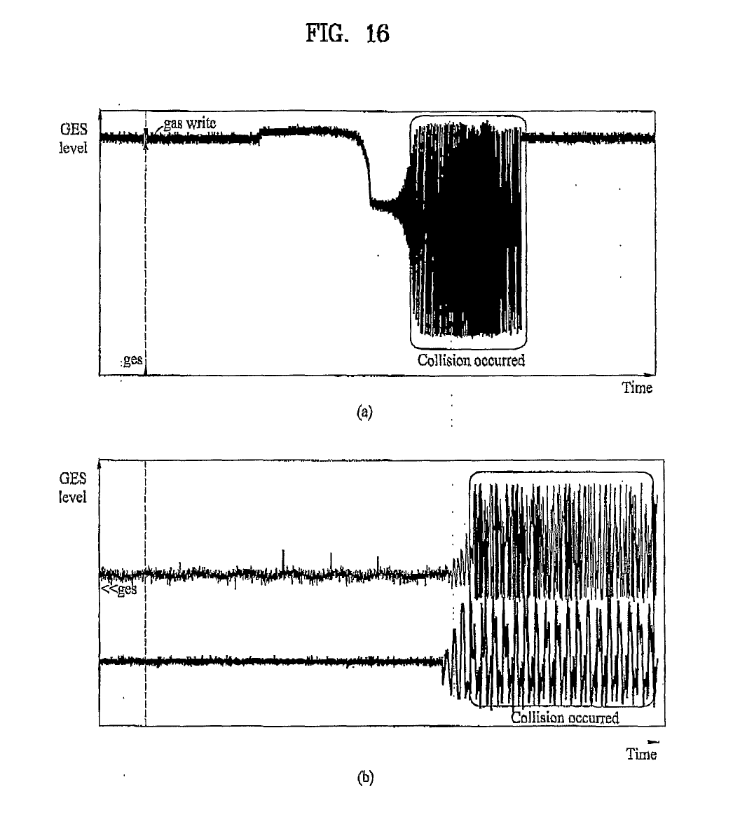

FIG. 14 is a flowchart illustrating a tilt adjustment mechanism for reducing the number of collisions between the recording medium and the lens according to a third embodiment of the present invention. FIG. 15 is a graph illustrating the result of comparison of waveforms of a GES level differently generated according to a tilt value according to a third embodiment of the present invention.

As shown in FIG. 14, under the condition that the initial tilt condition including a radial tilt or a tangential tilt is established at step Si, the recording medium is rotated and at the same time the gap servo operation is carried out at step S2, such that the GES waveform shown in FIG. 13(b) is generated in the recording medium including the defect or scratch. If it is determined that the detected number of repeating times and the magnitude of the signal level form an optimum waveform at step S5, a tilt condition under this optimum waveform is set to an optimum tilt condition at step S6. However, if the optimum waveform is not formed, the radial tilt or the tangential tilt is changed to change the initial tilt condition to a new tilt condition such that the new tilt condition is established at step S8. After that, steps S2 to S5 for detecting the GES waveform by rotating the recording medium can be repeated. In this case, the number of repeating times may be limited to a predetermined number at step S7, such that the above-mentioned steps are not infinitely repeated.

The magnitude of GES level and the number of waveform repeating times are shown in FIG. 15(a). The magnitude of the GES level shown in FIG. 15(a) is 80 nm, but the magnitude of the GES level shown in FIG. 15(b) is 50 nm, such that the GES level of FIG. 15(b) is more optimum than that of FIG. 15(a). FIG. 15(c) shows that the GES level is repeated two times, such that the GES level of FIG. 15(c) is more optimum than that of FIG. 15(a) showing that the GES level is repeated three times. The GES level shown in FIG. 15(d) is lower than that of FIG. 15(a), the number of repeating times in FIG. 15(d) is lower than that of FIG. 15(a), such that the most optimum GES waveform from among FIGS. 15(a)˜FIG. 15(d) can be recorded.

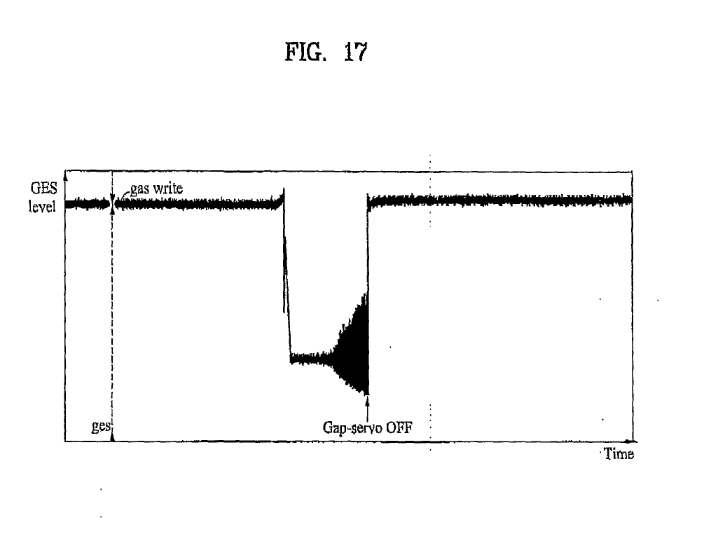

FIGS. 16 and 17 are graphs illustrating the result of comparison between one result acquired before the collision prevention method is used and the other result acquired after the collision prevention method is used according to a fourth embodiment of the present invention.

Referring to FIGS. 16 and 17, when the tilt between the SIL 42 and the recording medium 50 occurs or a servo gain is inaccurate, the gap servo starts its own oscillation and then the SIL 42 collides with the recording medium 50. In general, the unevenness of the GES waveform generated when there is a collision between the SIL 42 and the recording medium 50 is irregularly changed as shown in FIG. 16(a). Accordingly, if the gap servo operation is turned off at a time point where the gap servo starts oscillation, the collision between the SIL 42 and the recording medium 40 can be prevented. If the gap servo operation is turned off at the oscillation time point as shown in FIG. 17, the degree of irregular unevenness of the GES level is greatly reduced in a different way from FIG. 16.

In case of the tracking servo operation in addition to the gap servo operation, when the tilt between the SIL 42 and the recording medium 50 occurs or a servo gain is in-accurate, the tracking servo starts its own oscillation and then the SIL 42 collides with the recording medium 50, as can be seen from FIG. 16(b). Accordingly, when the tracking servo operation is halted (or is in a hold status) at the time point where the tracking servo starts its oscillation, and the oscillation is then stopped, the tracking servo operation is again performed, such that the collision between the SIL 42 and the recording medium 50 can be prevented.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Therefore, the above-mentioned detailed description must be considered only for illustrative purposes instead of restrictive purposes. The scope of the present invention must be decided by a rational analysis of the claims, and all modifications within equivalent ranges of the present invention are contained in the scope of the present invention.

### Mode for the Invention

Various embodiments have been described in the best mode for carrying out the invention.

### INDUSTRIAL APPLICABILITY

As apparent from the above description, the collision prevention method and an apparatus thereof according to the present invention can minimize the number of collision times generated when data is recorded and reproduced, such that a data playback quality can be greatly increased.

In addition, the collision prevention method and apparatus can reduce the number of generable collision tines under an optimum tilt condition, and can prevent the lens from being polluted by such collisions, thereby increasing the stability of a system.

1. A method for preventing a collision between a recording medium and a lens, the method comprising:
controlling a gap error signal (GES) between the recording medium and the lens to be maintained at a near field level;
detecting a collision between the recording medium and the lens;
pulling out the lens from the recording medium during a predetermined time so as to prevent a re-collision between the recording medium and the lens; and
re-controlling the gap error signal (GES) between the recording medium and the lens to be re-maintained at the near field level.

2. The method according to claim 1, further comprising:
if the gap error signal (GES) is changed to at least predetermined level or reaches a far field level, determining the occurrence of the collision between the recording medium and the lens.

3. The method according to claim 1, wherein the predetermined time is changed according to a defect or scratch size of the recording medium.

4. A method for preventing a collision between a recording medium and a lens, the method comprising:
recording a collision—occurred time point between the recording medium and the lens;
establishing a collision—occurred expectation area point using not only the collision—occurred time point but also a time consumed for one rotation of the recording medium; and
pulling out the lens from the recording medium during a predetermined time at the collision occurred expectation area point.

5. The method according to claim 4, wherein the predetermined time is changed according to a defect or scratch size of the recording medium.

6. The method according to claim 4, further comprising:
maintaining the pull-out status during a specific time shorter than the predetermined time.

7. A method for preventing a collision between a recording medium and a lens, the method comprising:
establishing an initial tilt condition between the lens and the recording medium;
detecting a gap error signal (GES) waveform caused by rotation of the recording medium under the condition that the initial tilt condition is established;
determining whether the tilt condition is an optimum condition on the basis of the gap error signal (GES) waveform; and changing, if the tilt condition is not the optimum condition, the tilt condition to a new tilt condition, and detecting the gap error signal (GES) waveform under the new tilt condition.

8. The method according to claim 7, wherein the gap error signal (GES) waveform includes information about a generation frequency of the gap error signal (GES) and information about a signal level magnitude.

9. An apparatus for preventing a collision between a recording medium and a lens, the apparatus comprising:
a lens for illuminating a light beam emitted from a light source on the recording medium; and
a control unit which controls a gap error signal (GES) between the recording medium and the lens to be maintained at a near field level, if a collision between the recording medium and the lens is detected, pulls out the lens from the recording medium for a predetermined time so as to prevent a re-collision between the recording medium and the lens, and then re-controls the gap error signal (GES) between the recording medium and the lens to be maintained at the near field level.

10. The apparatus according to claim 9, wherein if the gap error signal (GES) is changed to at least predetermined level or reaches a far field level, determines the occurrence of the collision between the recording medium and the lens.

11. The apparatus according to claim 9, wherein the predetermined time is changed according to a defect or scratch size of the recording medium.

12. An apparatus for preventing a collision between a recording medium and a lens, the apparatus comprising:
a lens for illuminating a light beam emitted from a light source on the recording medium; and
a control unit which records a collision—occurred time point between the recording medium and the lens, establishes a collision occurred expectation area point using not only the collision occurred time point but also a time consumed for one rotation of the recording medium, and pulls out the lens from the recording medium during a predetermined time at the collision—occurred expectation area point.

13. An apparatus for preventing a collision between a recording medium and a lens, the apparatus comprising:
a lens for illuminating a light beam emitted from a light source on the recording medium; and
a control unit which establishes an initial tilt condition between the lens and the recording medium, detects a gap error signal (GES) waveform caused by rotation of the recording medium under the condition that the initial tilt condition is established, determines whether the tilt condition is an optimum condition on the basis of the gap error signal (GES) waveform, changes the tilt condition to a new tilt condition if the tilt condition is not the optimum condition, and detects the gap error signal (GES) waveform under the new tilt condition.
